(19) United States
(12) Patent Application Publication
(10) Pub. No.: US 2008/0079600 A1
(43) Pub. Date: Apr. 3, 2008

(54) Programmable illuminated display sign

(76) Inventors: Nadwa Yono, West Bloomfield, MI (US); Brent C. Morse, Vermontville, MI (US)

Correspondence Address: MITCHELL M. MUSIAL II, PLLC, 6960 ABBOTT TERRACE, WEST BLOOMFIELD, MI, 48323, US

(21) Appl. No.: 11/906,005

(22) Filed: Sep. 28, 2007

Related U.S. Application Data
(60) Provisional application No. 60/848,287, filed on Sep. 28, 2006.

(51) Int. Cl. G09F 13/00

(52) U.S. Cl. 340/815.53

(57) ABSTRACT

Disclosed herein is a programmable illuminated airport greeter display sign. The sign has a display screen for displaying passenger information. The display sign is wireless, lightweight and portable to permit a user to carry and hold the sign. The sign is programmable to permit a user to enter information related to the passenger to be greeted as well as select information from one of a plurality of passengers to be greeted. Additionally, the apparatus may include programmable features such as flashing, scrolling and multicolor display. Indicia may be displayed on the case or on the screen for purposes of advertising, such as a limousine service, a restaurant, night club or the like.

### CROSS-REFERENCE TO RELATED APPLICATIONS

This application claims the benefit of and priority to prior filed co-pending U.S. provisional application Ser. No. 60/848,287, filed Sep. 28, 2006, the disclosure of which is incorporated herein by reference.

### FIELD OF THE INVENTION

The present invention relates to an illuminated display sign. More specifically, the apparatus is an illuminated programmable airport greeter display sign.

### BACKGROUND OF THE INVENTION

Anyone who has traveled has seen people waiting to greet passengers near the airport baggage claim terminals holding signs with names written on the signs. In most instances, these signs are nothing more than a piece of paper with names written in black marker. Other signs are printed by a commercial print process. The common similarity these signs all have is they fail to stand out and make a traveler feel important or special. A sign that attracts a passenger's attention would be an improvement in the field of airport greeting signs.

Additionally, an airport greeter is missing an important marketing opportunity. Companies are always looking for new advertising “real estate”. A sign that could provide promotional or advertising information on it would prove to be beneficial to companies involved in greeting arriving passengers.

As electronics and illuminated displays become more affordable, illuminated signs become a more appealing way of greeting passengers than using paper signs. An illuminated display sign would provide many advantages. The passenger would be able to clearly see their name, as legibility would no longer be a problem. Additional messages could be provided as well. In addition, several passenger records could be loaded into a single sign, so preparing additional signs would not be necessary.

One such system that provides an illuminated display sign is described in U.S. Pat. No. 4,574,269. The '269 patent discloses a visual communicator for a rear window of a vehicle. The communicator is semi-transparent and adapted to be disposed in the rear window of the vehicle for viewing from outside of the vehicle. The communicator includes a message control unit for selectively energizing the light emitting diodes in any one of a plurality of preselected patterns. One shortcoming of the '269 patent is it is clearly not humanly portable. Another shortcoming is it is not user programmable.

Another system that provides an illuminated display sign is described in U.S. Pat. No. 6,271,814. The '814 patent discloses a dual message advertising display system having a variable electronic display and a fixed printed display formed on a shared display screen. The display screen includes fixed information printed thereon, such as an advertisement, logo, or other message. One shortcoming of the '814 patent is it is clearly not designed to be hand held. Another shortcoming is the messages are not user selectable. Additionally, the system does not provide for a means for entering data in the field.

Still another such system that provides an illuminated display sign is described in U.S. Pat. No. 6,880,276. The '276 patent discloses an illuminated electronic display that employs a plurality of fiber optic strands to enable light emitted from the light source to enter a display array to form characters in a message that is desired to be displayed to an intended viewer. One shortcoming of the '276 patent is it is clearly not designed to be humanly portable. Additionally, the system is not user programmable or provide memory storage for messages that are user selectable.

Still yet another such system that provides an illuminated display sign is described in U.S. Pat. No. 6,154,994. The '994 patent discloses a portable lightweight illuminated sign assembly for either carrying on one's person or placing on a window for advertisement and the like. Although portable, the '994 patent is clearly not programmable or user selectable.

Thus, it is desirable to provide a programmable illuminated display sign for greeting a passenger that is portable. It is also desirable to provide an illuminated display sign that permits a user to select one passenger's information from a plurality of passengers for display.

### SUMMARY OF THE INVENTION

A wireless illuminated display sign for displaying passenger information to signal a passenger comprises a case having a display screen fixedly attached to said case for displaying a signal to a passenger, a programmable controller having a central processing unit and memory storage, where the memory storage adapted to receive instructions. The instructions are executable by the controller to (a) receive passenger information to be displayed on the display screen, and (b) command the controller to display selected passenger information, where passenger information is selected from the group consisting of a passenger name, a passenger affiliation, a passenger destination, a passenger origin, a passenger greeting and passenger flight information. The passenger information is selectable by a user. A user operated input device is provided for selecting passenger information to be displayed on display screen. One passenger record of a plurality of records may be selected. The passenger information may be identified to the user by flight number, flight time, or passenger name, which may or may not be display on the display screen.

The wireless illuminated display sign further comprises instructions to display a main menu to permit a user to select a passenger and to enter passenger information. The wireless illuminated display sign may also include instructions to display a passenger menu to permit a user to select a passenger and to enter passenger information. The sign may also contain instructions to display a select menu to permit a user to select a passenger to have that passengers display information display on the display screen.

The wireless illuminated display sign for displaying passenger information to signal a passenger may also comprise a separate memory storage to store passenger information. The passenger information may be obtained from an external source. The display sign may also comprise an indicia, such as advertising statement, which may be illuminated, static, or applied to the display sign. Additionally, the indicia may be located on the display screen.

A wireless illuminated display sign for displaying passenger information to signal a passenger comprises a case having a display screen for displaying passenger information, where the display screen has a display input. A user operated input device is provided that produces an input select signal indicative of mode selection. A control circuit is connected to the input device and the display screen and responds to the input select signal by producing display signals that are applied to the display input. The control circuit has a first mode of operation when the input select signal commands a select menu where the display screen displays a select menu. The control circuit also has a second mode of operation when the input select signal commands a program menu where the display screen displays a program menu. Additionally, the control circuit has a third mode of operation when the input select signal commands a passenger display where the display screen displays passenger information. During the second mode, the control circuit may produce a display signal to display an on-screen keyboard on the display screen. Passenger information may be organized in a database capable of storing a plurality of records, the records may be organized by identifiers such as passenger name, flight number or arrival time. A user operated input device may be disposed on the display side of the display sign to permit a user to view the on-screen keyboard while operating the input device.

Further objects, features and advantages of the present invention will become apparent to those skilled in the art from analysis of the following written description, the accompanying drawings and the appended claims.

### BRIEF DESCRIPTION OF THE DRAWINGS

FIG. 1 is a plan view of a illuminated display sign according to the principles of the present invention; and

FIG. 2 is an exemplary block diagram of the illuminated display sign according to the principles of the present invention; and

FIG. 3 is a plan view of a illuminated display sign according to the principles of the present invention, revealing an exemplary menu system; and

FIG. 4 is a plan view of a illuminated display sign according to the principles of the present invention, revealing an on-screen keyboard; and

### DESCRIPTION OF THE PREFERRED EMBODIMENT

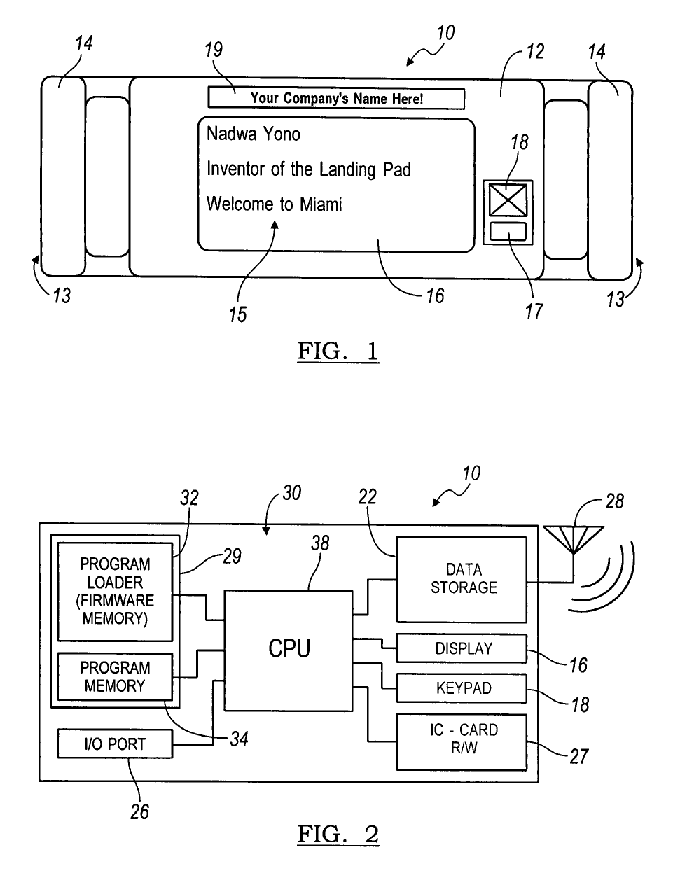

With initial reference to FIG. 1, a plan view of an illuminated display sign 10 according to the principles of the present invention is shown. The display sign 10 comprises a case 12 having at least one grip portion 14 thereon to enable a user to hold the display sign 10. In the preferred embodiment, the grip portion 14 is a pair of grips 14 disposed at side portions 13 of the case 12. The case 12 has a display screen 16 that includes a display input (not shown) for receiving display signals. The display screen 16 displays a signal or message 15 to a passenger. In the preferred embodiment, the display screen is a light emitting diode (LED) array, however, other display types such as liquid crystal display (LCD) or vacuum florescent, as examples, may be employed. The display sign 10 may also comprise an indicia 19, such as advertising statement, which may be displayed on a separate display screen. The indicia 19 may be illuminated, flashing, static, or applied to the display sign 10 without a display screen. Additionally, the indicia 19 may be located on the display screen 16.

The signal 15 may include passenger information, selected from the group consisting of a passenger name, a passenger affiliation, a passenger destination, a passenger origin, a passenger greeting and passenger flight information. In the exemplary embodiment of FIG. 1, the sign 10 is in “Display Mode”, displaying a signal 15 that includes a passenger name, passenger affiliation and a passenger greeting. A user operated input device 18 is provided to enter and select passenger information to be displayed. In the preferred embodiment, the input device 18 is a four button keypad adapted to move a cursor on the display screen 16. An “enter” button 17 is provided to select information.

Referring now also to FIG. 2, an exemplary block diagram of the illuminated display sign 10 according to the principles of the present invention is shown. Display sign 10 comprises data storage 22, an IO port 26, display screen 16, keypad 18 and memory card reader 27 in communication with a control circuit 30. One or more display drivers (not shown) may be employed to render images on the display screen. In the preferred embodiment, one display driver is provided for each line of text to be displayed. Passenger information may be generated remotely and written on a memory card (not shown) and transferred to the data storage 22 through the memory card reader 27. An antenna 28 is in communication with the control circuit 30 and enables display sign 10 to receive passenger information data wirelessly. Alternatively, IO port 26 may enable the display sign 10 to receive data, instead of, or in addition to antenna 28 or via memory card at the memory card reader 27. It should be noted however, that any communication technology known the art including infrared, laser, or radio, such as Bluetooth®, may be employed to enable the display sign 10 to receive data. Additionally, the sign 10 may be web based or controlled through a network such as the Internet, whereby the sign 10 may receive signals, information, activation or deactivation data, such as in the form of a “cookie”, as an example. In the preferred embodiment, power is provided by one or more electrochemical storage cells, however, any suitable substitute may be employed to power the sign 10.

In the preferred embodiment, the control circuit 30, or controller, is a programmable single integrated circuit microcontroller having a central processing unit (CPU) 38, input/output interfaces such as serial ports (not shown), memory 29 comprising ROM 32 for program storage and RAM 34 for data storage, and an oscillator for coupling to a quartz timing crystal, resonator or RC circuit (not shown). A computer program, also known as firmware, is stored in the ROM 32. The firmware provides instructions to control the microcontroller 30. In the preferred embodiment, the memory storage device 32 is a non-volatile memory storage device, such as a flash memory device. Program instructions executable by the controller 30 are stored on the ROM 32, which in the present embodiment is an EEPROM, an acronym for erasable programmable read-only memory. It should be noted that although an EEPROM is disclosed herein, any type of programmable memory may be employed in the present invention.

Data storage 22 is provided to store passenger information, which may be stored as records. Each record contains passenger information to be displayed on the display screen 16. Passenger information may be organized in a database contained in the data storage device 22, where the database is capable of storing a plurality of records. The records may be organized by identifiers such as passenger name, flight number or arrival time. In one embodiment, the identifiers are displayable only to the user and not displayed on the display screen 16. Alternatively, the identifier may be the passenger's name or any other passenger information that is intended to be displayed on the display screen 16. The display sign 10 may function as a schedule for the user to identify the passengers to be greeted on a particular day.

The firmware contains instructions to cause the controller 30 to receive passenger information to be displayed and to command the controller to display selected information. The passenger information to be displayed is selectable by a user.

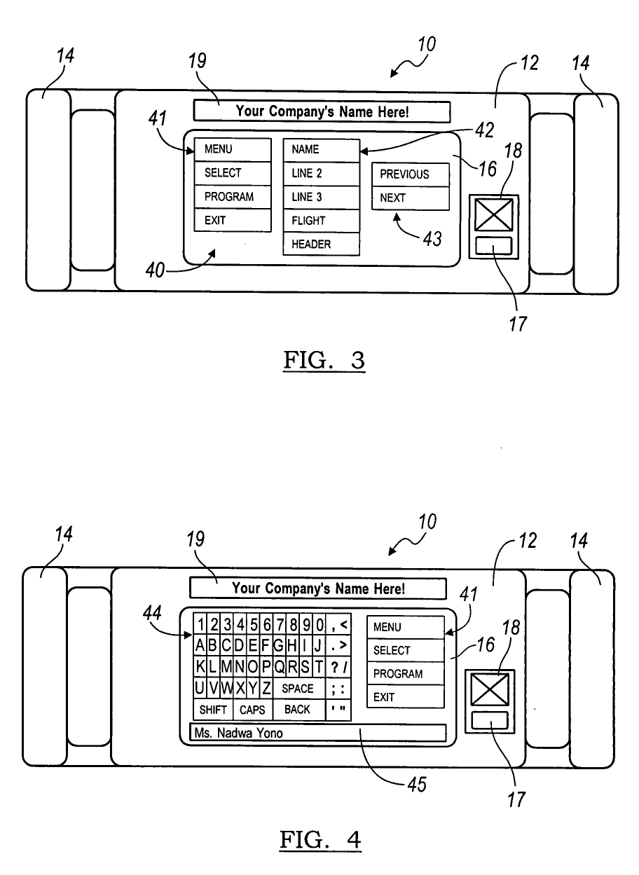

Referring now to FIG. 3, a plan view of the illuminated display sign 10 according to the principles of the present invention is shown, revealing an exemplary menu system 40. The operation of the display sign will be described with reference to FIGS. 3 and 4. When the sign 10 is in “Display Mode” a user may display the main menu 41 by pressing the enter button 17. The enter button 17 has a momentary contact switch that supplies an input select signal to the microcontroller 30. The input signal commands the controller to cause a main menu 41 to be displayed when the sign 10 is in “display mode”.

From the main menu, a user may command the sign 10 to display the select menu 43, the program menu 42 or the “display mode”. The cursor is positioned on the screen by using the four button keypad 18. An “enter” button 17 is provided to select information. In a first mode of operation, an input select signal commands a select menu 43 to be displayed on the display screen 16. To display the select menu 43, a user positions the cursor (not shown) over the select button on the main menu 41 and presses the enter button 17. The controller responds to the input select signal by producing display signals to a display input (not shown), commanding the select menu 43 to be displayed on the display screen 16. A user may scroll through the passengers stored in the data storage 22 until the desired passenger is identified. The passengers may be organized by identifiers such as passenger name, flight number or arrival time. The passenger identifier may or may not be displayed on the display screen 16 as part of the passenger information. When the desired passenger is identified, the cursor is positioned over the exit button on the main menu 41, and the passenger information is displayed in the form of a signal 15, as shown in FIG. 1.

In a second mode of operation, an input select signal commands a program menu 42 to be displayed on the display screen 16. To display the program menu 42, a user positions the cursor (not shown) over the program button on the main menu 41 and presses the enter button 17. The controller responds to the input select signal generated by the enter button by producing display signals to the display input (not shown), commanding the program menu 42 to be displayed on the display screen 16. A user may then position the cursor over the Name, Line 2, Line 3, Flight, or Header buttons. A user may program the name of a passenger in the Name field. Other information may be entered on Line 2 and Line 3, such as passenger affiliation or a greeting. An identifier may be entered by selecting the Header button. The user may decide weather to display the passenger identifier in the Header field on the display screen 16 as part of the signal 15. To program, for example, a passenger name, a user will position the cursor over the Name button on the program menu and then press the enter button which will generate an on-screen alphanumeric keyboard.

Referring now also to FIG. 4, a plan view of the illuminated display sign 10 according to the principles of the present invention is shown, revealing an on-screen keyboard 45. In the immediate example, a passenger name is programmed in the Name field of the passenger record by positioning the cursor over the symbol to be selected and pressing the enter button 17. The passenger information is displayed in a preview box 45 as it is entered. Once all of the desired passenger information is entered into the passenger record, the Exit button is selected, taking the user back to the program menu 42. A user may then continue to enter passenger information in other fields. When completed, a user may command a third mode of operation by selecting Exit again by positioning the cursor over the exit button on the main menu 41 and pressing the enter button 17 to generate an input select signal, where the input select signal commands a passenger display screen to display passenger information in the form of a signal 15 to signal or attract a passenger.

A variety of screen and type colors may be selected as well as features such as flashing, scrolling or other special effects that are displayable on the display screen 16 of the display sign 10. As such, the sign 10 of the present invention provides desirable features that will create a memorable experience for a traveler as well as utility to the user.

The foregoing discussion discloses and describes the preferred structure and control system for the present invention. However, one skilled in the art will readily recognize from such discussion, and from the accompanying drawings and claims, that various changes, modifications and variations can be made therein without departing from the true spirit and fair scope of the invention as defined in the following claims.

What is claimed is:

1. A wireless illuminated display sign for displaying passenger information to signal a passenger, comprising:
a case having a display screen fixedly attached to said case for displaying a signal to a passenger;
a programmable controller having a central processing unit and memory storage, said memory storage adapted to receive instructions;
instructions executable by said controller to (a) receive passenger information to be displayed on said display screen, and (b) command said controller to display selected passenger information, where passenger information is selected from the group consisting of a passenger name, a passenger affiliation, a passenger destination, a passenger origin, a passenger greeting and a passenger flight information, where said passenger information is selectable by a user; and
a user operated input device for selecting passenger information to be displayed on display screen.

2. The wireless illuminated display sign for displaying passenger information to signal a passenger as set forth in claim 1, further comprising instructions to display a main menu to permit a user to select a passenger and to enter passenger information.

3. The wireless illuminated display sign for displaying passenger information to signal a passenger as set forth in claim 1, further comprising instructions to display a passenger menu to permit a user to select a passenger and to enter passenger information.

4. The wireless illuminated display sign for displaying passenger information to signal a passenger as set forth in claim 1, further comprising instructions to display a select menu to permit a user to select a passenger to display on the display screen.

5. The wireless illuminated display sign for displaying passenger information to signal a passenger as set forth in claim 1, further comprising memory storage to store passenger information.

6. The wireless illuminated display sign for displaying passenger information to signal a passenger as set forth in claim 5, containing an input device for obtaining passenger information obtained from an external source, the input device selected from the group consisting of a card reader, an antenna and an IO port.

7. The wireless illuminated display sign for displaying passenger information to signal a passenger as set forth in claim 1, further comprising an indicia.

8. The wireless illuminated display sign for displaying passenger information to signal a passenger as set forth in claim 7, wherein said indicia is located on said display screen.

9. The wireless illuminated display sign for displaying passenger information to signal a passenger as set forth in claim 7, wherein said indicia is located on said case.

10. A wireless illuminated display sign for displaying passenger information to signal a passenger, comprising:
a case having a display screen for displaying passenger information, said display screen having a display input;
a user operated input device for producing an input select signal indicative of mode selection; and
a control circuit connected to the input device and the display screen and responding to the input select signal by producing display signals that are applied to the display input, the control circuit having a first mode of operation when the input select signal commands a select menu wherein the display screen displays a select menu, a second mode of operation when the input select signal commands a program menu wherein the display screen displays a program menu, and a third mode of operation when the input select signal commands a passenger display wherein the display screen displays passenger information.

11. The wireless illuminated display sign for displaying passenger information to signal a passenger as set forth in claim 10, further comprising instructions to display a main menu to permit a user to select a passenger and to enter passenger information.

12. The wireless illuminated display sign for displaying passenger information to signal a passenger as set forth in claim 10, further comprising instructions to display a passenger menu to permit a user to select a passenger and to enter passenger information.

13. The wireless illuminated display sign for displaying passenger information to signal a passenger as set forth in claim 10, further comprising instructions to display a select menu to permit a user to select a passenger to display on the display screen.

14. The wireless illuminated display sign for displaying passenger information to signal a passenger as set forth in claim 10, further comprising an indicia.

15. In a wireless illuminated display sign for displaying passenger information to signal a passenger of the type comprising a case and a display screen fixedly attached to the case and a programmable controller having a central processing unit and memory storage, the memory storage adapted to receive instructions and a user operated input device for selecting information to be displayed on display screen, the improvement comprising:
instructions executable by the controller to (a) receive passenger information to be displayed on said display screen, and (b) command the controller to display selected passenger information, where passenger information is selected from the group consisting of a passenger name, a passenger affiliation, a passenger destination, a passenger origin, a passenger greeting and a passenger flight information, where said passenger information is selectable by a user.

16. The wireless illuminated display sign for displaying passenger information to signal a passenger as set forth in claim 15, the improvement further comprising instructions to display a main menu to permit a user to select a passenger and to enter passenger information.

17. The wireless illuminated display sign for displaying passenger information to signal a passenger as set forth in claim 15, the improvement further comprising further comprising instructions to display a passenger menu to permit a user to select a passenger and to enter passenger information.

18. The wireless illuminated display sign for displaying passenger information to signal a passenger as set forth in claim 15, the improvement further comprising instructions to display a select menu to permit a user to select a passenger to display on the display screen.
